(19) United States
(12) Patent Application Publication
(10) Pub. No.: US 2001/0036074 A1
(43) Pub. Date: Nov. 1, 2001

(54) Multi-function super-thin indicator

(76) Inventor: Shaw-Jong Wang, Hsinchu (TW)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/813,174

(22) Filed: Mar. 20, 2001

(30) Foreign Application Priority Data
Apr. 28, 2000 (TW) 89/207,030

(51) Int. Cl. F21W 121/06; F21W 131/40

(52) U.S. Cl. 362/156; 362/253; 362/812; 362/106; 362/103; 362/108

(57) ABSTRACT

The present invention relates to a multi-function super-thin indicator comprising a thin electroluminescent plate having a lightening portion being provided in a lightening area representing substantially the same displaying area of a light emitting diode. The lightening portion is divided into several sub-lightening portions, which contain plural lightening segments lined circularly in sequence. Every sub-lightening portion constitutes a brighten figure of figure portion stacked on the lightening portion to form indicators showing various expressions in substantially the same area to show various colorful effects within the same expression. Furthermore, the indicator can be applied to various kinds of objects or marks to make them vivid.

### BACKGROUND OF THE INVENTION

1. Field of the Invention

The present invention relates to a multi-function super-thin indicator, in particular, to a super-thin indicator that can reveal various neon effects and show a variety of vivid expressions.

2. Description of Prior Art

Signboard and fascia in the past can only show one expression and be represented by strict color and shape at the same displaying area and thus lack vividness.

Besides, though it is known to make the signboard vivid and show different expressions in the same area through the use of neon, the expressions and the types of the figures that can be shown are still limited. Moreover, the signboards consume a lot of electricity and occupy wider space.

### SUMMARY OF THE INVENTION

The purpose of the present invention is to provide a multi-function super-thin indicator that can reveal various kinds of expressions and the better effects of expressions.

Another purpose of the present invention is to provide a multi-function super-thin indicator that is light and handy, dangerous-free, saves electricity and space, and has the expression effect of neon.

To achieve the purposes mentioned above, the present invention first discloses a multi-function super-thin indicator comprising a thin electroluminescent laminate including a lightening area and a lightening portion representing substantially the same displaying area. Many hypothetical mutual parallel sub-lightening areas constitute said lightening area. The sub-lightening areas are divided into N groups wherein N is a positive integer greater than 1, and the sub-lightening areas are divided from first group to Nth group in sequence from one side to the other side repeatedly. Said lightening portion includes N group self-luminance sub-lightening portions and each sub-lightening portion is constituted by several lightening segments, which are substantially mutual parallel and separated to each other. Each lightening segment corresponds to a sub-lightening area. Moreover, each lightening segment of the same sub-lightening portion is arranged into one of said sub-lightening area groups and constitutes a specific figure. This can lead to several figure sets constituted by said sub-lightening portion.

To achieve the purposes mentioned above, the present invention further discloses a multi-function super-thin indicator comprising:

A thin electroluminescent laminate which comprises a lightening portion representing substantially the same displaying area, and said lightening portion comprises plural sets of sub-lightening portions that can self-luminance Several stripe-shaped lightening segments, which are substantially mutual parallel and separated to each other, constitute each sub-lightening portion. There is a lightening segment that belongs to other sub-lightening portion being plugged in between two lightening segments next to each other of the same sub-lightening portion; and:

A figure portion, which is stacked on said lightening portion, comprises several sets of figures and every set of figures is constituted by several stripe-shaped figure segments that are substantially mutual parallel and separated to each other. Every figure segment corresponds in location to one of said lightening segments. Every set of figures corresponds in location to one of said sub-lightening portions and is lightened by one of said correspondent sub-lightening portions.

In the description above, the lightening portion is divided into several sets of sub-lightening portions; the sub-lightening portions, which are substantially located at the same displaying area, are separated to each other by every lightening segment of different sub-lightening portions and able to be lightened by different sub-lightening portions or different lightening segments of the same lightening portion to make the indicator show various expressions selectively or reveal plenty of effects of the same expression at the substantially same area. This can lead to an indicator with multiple effects.

For example, by printing the figure onto a front mask that is stacked on the surface of lightening portion of said lightened apparatus to get more kinds of expressions through the change of expressed figures that will be done by the change of the front mask. It is really a great advantage to the users who want to reduce the budget and hope to change the expressed contents by the most economical manner.

The purpose, characteristics, and effects of the present invention will be better understood with the aid of the following description and of the drawings, in which:

### BRIEF DESCRIPTION OF THE DRAWINGS

FIG. 1 is a 3-D figure of multi-function super-thin indicator in accordance with the first embodiment of the present invention.

FIG. 2 is a plain figure of multi-function super-thin indicator in accordance with the second embodiment of the present invention.

FIG. 3 is a 3-D decomposed figure of multi-function super-thin indicator in accordance with the third embodiment of the present invention.

FIG. 4 is a 3-D figure of above first embodiment applied to a backpack.

FIG. 5 is a 3-D figure of above third embodiment applied to a belt.

FIG. 6 is a 3-D figure of above second embodiment applied to a glass door.

### DETAILED DESCRIPTION OF THE PREFERRED EMBODIMENT

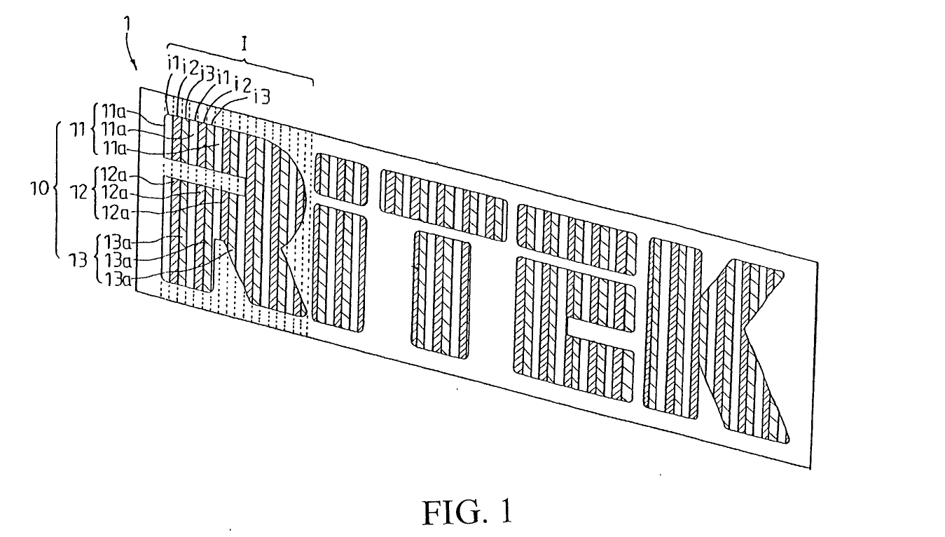

FIG. 1 shows the first embodiment of the multi-function super-thin indicator in accordance with the present invention. As shown in FIG. 1, this embodiment illustrates a multi-function super-thin indicator constituted mainly by a thin light emitting diode 1 and said light emitting diode further comprising: a lightening area I and a lightening portion 10 representing substantially the same displaying area. However, said light emitting diode 1 can also be made by other thin displaying apparatus, such as organic electroluminescent device.

Lightening area I is divided into several hypothetically mutual parallel sub-lightening areas as shown by dotted lines of FIG. 1, and each hypothetical sub-lightening area is further divided to three groups repeatedly, namely i1, i2, and i3 respectively, from left side to right side of the said lightening area.

Lightening portion 10 is divided to three groups that can be lightened by themselves, namely the first sub-lightening portion 11, the second sub-lightening portion 12, and the third sub-lightening porting 13, respectively. Lightening segments 11a, 12a, and 13a, which are substantially mutual parallel and separated to each other, constitute sub-lightening portion 11, 12, and 13. Every lightening segment is corresponding to a sub-lightening area, and each lightening segment that belongs to the same sub-lightening portion is arranged into one of sub-lightening areas to constitute a specific figure. For example, each lightening segment 11a of sub-lightening portion is arranged into one of sub-lightening areas i1, and together they form a figure “R” that seems being constituted by many separated straight lines. In view of the above, each lightening segment of every sub-lightening portion constitutes a set of figures, thus three sets of sub-lightening portions constitute three sets of figures. Furthermore, in this example, each set of figures expresses the same expression “R”, but the color of the first sub-lightening portion 11 is blue, the color of the second lightening portion 12 is brown, and the color of the third sub-lightening portion 13 is green. So this is the case that in the substantially same lightening area I the figure of “R” is constituted by several figures and is gradient in color, that is to say we can have the same expression with different color effects. Besides, it includes five said lightening areas at the substantially same area, where figures such as “I”, “T”, “E”, and “K” are formed respectively.

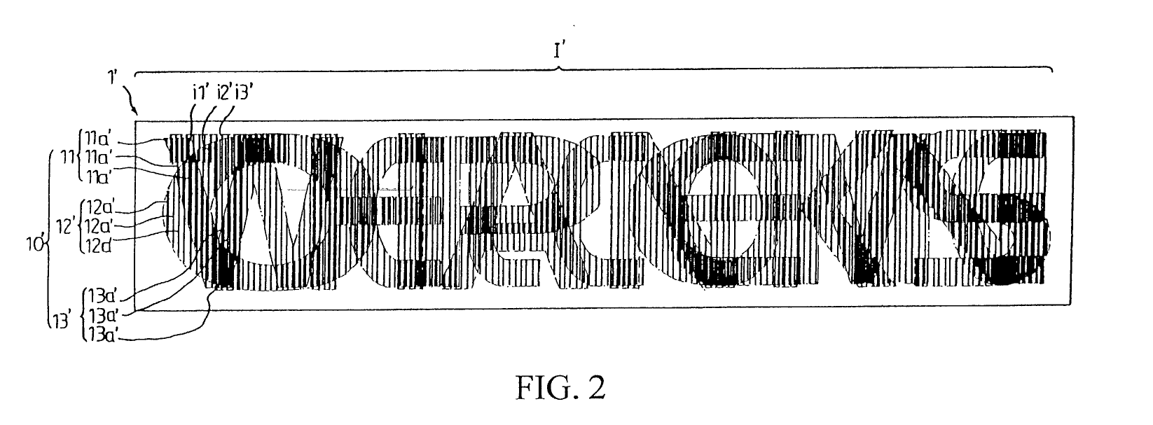

FIG. 2 shows the second example of multi-function super-thin indicator in accordance with the present invention. As shown in FIG. 2, this embodiment is similar to the first one, said indicator is also constituted by a thin light emitting diode 1′, and the light emitting diode 1′ comprises a lightening area I′ and a lightening portion 10′ represented substantially same area; but lightening area I′ comprises the whole indicating area. Lightening area I′ is also divided into multiple mutual parallel hypothetically sub-lightening area from left side to right side of the lightening area I′ as the dotted line in FIG. 2 shows, and they are separated to three sets marked as i1′, i2′, and i3′ respectively.

Lightening portion 10′ is also divided into three sets, namely the first sub-lightening 11′, the second sub-lightening portion 12′, and the third sub-lightening portion 13′, that can self-luminance. Each sub-lightening portion i1′, i2′, and i3′ is constituted by several lightening segments 11a′, 12a′, and 13a′ which are substantially mutual parallel and separated to each other. Each lightening segment is corresponding to a hypothetical sub-lightening area; each lightening section that belongs to the same sub-lightening portion is also arranged into one set of sub-lightening areas and constitutes one specific figure set. But, in this example, each figure set further comprises several sub figures and represents different expressions at the substantially same area. For example, each lightening segment 11a′ of the first lightening portion 11′ is arranged to each sub-lightening area iI′ and together they constitute one figure set “OPEN” that seems like being constituted by several separated straight lines, and “O”, “P”, “E”, and “N” are the sub figures of the figure set respectively; each lightening segment 12a′ of the second sub-lightening portion 12′ is arranged to each sub-lightening area i2′ and together they constitute one figure set “WELCOME” that seems like being constituted by several separated straight lines, and “W”, “EE”, “L”, “C”, “O”, “M”, and “E” are the sub figures of the figure set respectively. Each lightening segment 13a′ of the third sub-lightening portion 13′ is located to each sub-lightening area i3′ and together they constitute one figure set “THANKS” that seems like being constituted by several separated straight lines, and “T”, “H”, “A”, “N”, “K”, and “S” are the sub figures of the figure set respectively.

Furthermore, in the second example described above, to make the figure constituted by each lightening portion look like being constituted by several sub figures, each lightening section of the same sub-lightening portion can also be divided into several groups due to the differences between sub figures. So each sub-lightening portion can be gradually activated to emitting light in accordance with different lightening groups. Besides, the color of each sub-lightening portion or lightening groups can be changed arbitrarily, like in the present example, the color of “OPEN” is red, “WELCOME” is yellow, and “THANKS” is blue. In other situations, we can also make the color of “O” of “OPEN” red, make “P” blue, and etc.

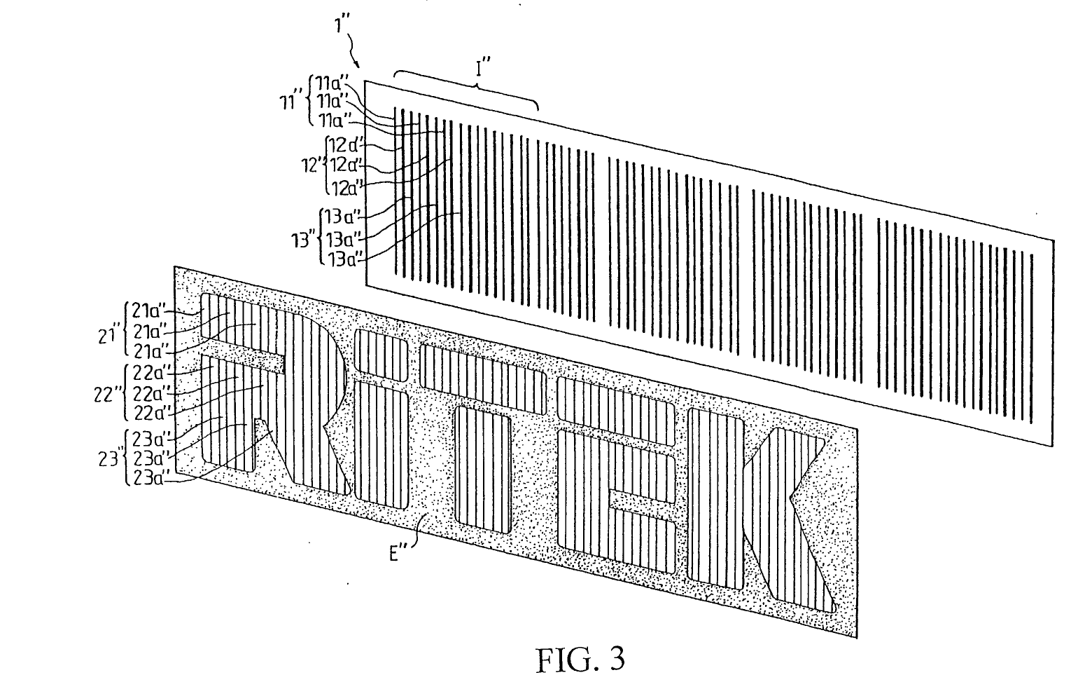

FIG. 3 shows the third example of multi-function super-thin indicator in accordance with the present invention. As FIG. 3 shows, the multi-action thin indicating means comprises: a thin light emitting diode 1″ for emitting light, a figure portion for expressing figures, and a front mask 2″ that can be changed to stack on said light emitting diode 1″.

Light emitting diode 1″ comprises several lightening area I″ represented substantially same area respectively and a lightening portion 10″; lightening portion 10″ further comprises three sets of sub-lightening portion that can emit light separately, namely the first sub-lightening portion 11″, the second sub-lightening portion 12″, and the third sub-lightening portion 13″. Each sub-lightening portion is constituted by several stripe-shaped lightening segment 11a″, 12a″, and 13a″, which are substantially parallel and separated to each other, and each lightening segment is arranged in a way that a lightening segment that belongs to other sub-lightening portion is plugged in between two adjacent lightening segments of the same sub-lightening portion. That is to say, each lightening segment, which is just like the hypothetical sub-lightening areas of the first example, is divided into three sets, such as set 1, set 2, and set 3, from the left side to the right side of the lightening area I″ repeatedly.

Front mask 2″ can be constituted by any suitable thin film such as plastic film, there are three sets of figures above it, the first FIG. 21″, the second FIG. 22″, and the third FIG. 23′, represent substantially same meaning; each set of figures is constituted by plural stripe-shaped FIG. segments 21a″, 22a″, and 23a″ that are substantially mutual parallel and separate to each other; each figure segment 21a″, 22a″, and 23a″ is corresponding in location to each lightening segment 11a″, 12a″, and 13a″, and each set of figures is corresponding to one of the said sub-lightening portions, thus can be lightened by corresponding sub-lightening portion. For example, figure set 21″ of figure sets corresponds to sub-lightening portion 11″ of sub-lightening portions. Furthermore, area E″, which is located outside the area of figures of the whole front mask 2″, is made to be a non-transparent area, so that the light being emitted by the part of every lightening segment that is not covered by its correspondent figure segment of figure portion will not pass through front mask 2″ to affect vision effects.

In the third example described above, lightening portion 10″ can be made by just one standard no matter what kind of figure desired to be shown. That is to say, different figures can be shown just by replacing the front mask 2″ stacked on the lightening portion 10″ that has the same standard with it with a front mask that has a different figure from previous one, and making each figure segment correspond in location to each lightening segment.

Furthermore, although front mask 2″ is used in the example to be the loader to represent various kinds of figures and can be displaced according to actual situation, but figures can be formed on a thin film (not shown) as well, then tightly glued on the surface of the lightening portion 10″ directly. Another alternative is to print figures and non-transparent portion E″ directly on the surface of the lightening portion 10″.

With indicator disclosed in the embodiment described above, various kinds of expression can be shown at the substantially same area, or the same expression (figure) can be shown in various colors, and the lightening sequence of each lightening segment could differ according to each sub-lightening portion group or each lightening group to obtain all kinds of effects similar to neon light. Moreover, the indicator of the present invention is made from ultra thin electroluminescent plate, so that we can have a multi-function super-thin indicator.

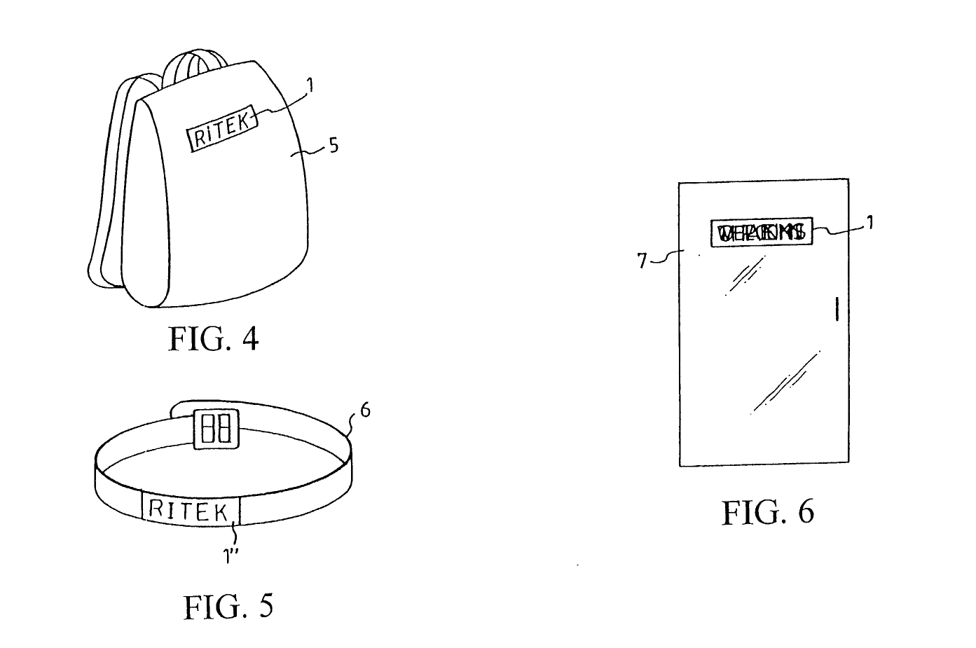

FIG. 4 shows the situation of the disclosed indicator 1 in the first embodiment described above applied on a backpack 5. As shown in FIG. 4, we can get a shining and colorful effect by installing the indicator 1 on the surface of the backpack 5 and supplying power by batteries, it is especially useful at night.

FIG. 5 shows the situation of the disclosed indicator 1″ in the third embodiment described above applied on a belt. As shown in FIG. 5, it is eye-catching by installing the indicator 1″ on the surface of the belt 6. A belt with entertaining or artistic effect can be obtained by changing the figure to be shown.

FIG. 6 shows the situation of the disclosed indicator 1′ in the second embodiment described above applied on a glass door. Except for the function of providing marks, it can further show various kinds of expressions at the same area. For example, normally the mark on door shows “OPEN”; but when somebody approaches, it shows “WELCOME”; and when somebody leaves, it shows “THANKS.”

It is clear in the embodiments above that due to the function of providing various kinds of marking effects, the indicator of the present invention can be extensively applied in different applications. For example, except for samples mentioned above, the indicator of the present invention can also be applied on objects that need many expressions or lots of different effects in the same expression, such as indoor or outdoor signboard, all kinds of markings, decorated film on windows of cars, decorated film on hats, reflex clothes, decorated film on shoes, watches, and etc.

Moreover, for a better continuity of each figure group, one can install an extended board (not shown) on the surface of lightening portion or front mask to make the lines of every figure more complete. And each lightening segment can also be made as circular form or spot form.

The technical contents and features of the present invention are disclosed above. However, anyone that is familiar with the technique can modify or change the details in accordance with the present invention without departing from the technologic ideas and spirit of the invention. The protection scope of the present invention shall not be limited to what embodiment discloses, it shall include various modifications and changes that are made without departing from the technologic ideas and spirit of the invention, and shall be covered by the claims mentioned below.

What is claimed is:

1. multi-function super-thin indicator comprising:
a thin electroluminescent laminate having a lightening area and a lightening portion representing substantially the same displaying area; many hypothetical mutual parallel sub-lightening areas constituting said lightening area; sub-lightening areas being divided into N groups wherein N is a positive integer greater than 1; and sub-lightening areas being divided from first group to Nth group in sequence from one side to the other side repeatedly; said lightening portion including N group self-luminance sub-lightening portions and each sub-lightening portion being constituted by several lightening segments, which are substantially mutual parallel and separated to each other; each lightening segment corresponding to a sub-lightening area; and each lightening segment of same sub-lightening portion being arranged into one of said sub-lightening area groups and thus constituting a specific figure; thereby several figure sets are constituted by said sub-lightening portion.

2. The indicator according to claim 1, wherein the indicator further comprises a front mask, it can be stacked on the lightening portion, and the figure portion is printed on the front mask; each figure segment corresponds to one of the lightening segments, and each set of figures corresponds to one of the sub-lightening portions.

3. The indicator according to claim 1, wherein the figure portion is printed directly on the lightening portion; each figure segment corresponds to one of the lightening segments, and each set of figures corresponds to one of the sub-lightening portions.

4. The indicator according to claim 1, wherein the groups of figures represent different meanings.

5. The indicator according to claim 4, wherein the sub-lightening portions can luminesce independently or separately, so that the lightening portion is adapted to luminesce after the other lightening portions have luminesced.

6. The indicator according to claim 5, each set of figures further contains several sub figures, the lightening segment of each sub-lightening portion is divided into several groups, each lightening segment corresponds to a sub figure, and each group of lightening segment luminesces one by one in sequence.

7. The indicator according to claim 1, wherein the sets of figures represent the same meaning.

8. The indicator according to claim 7, wherein the sub-lightening portions luminesce one by one in sequence.

9. The indicator according to claim 1, wherein said indicator is installed on a backpack.

10. The indicator according to claim 1, wherein said indicator is installed on a belt.

11. The indicator according to claim 1, wherein said indicator is applied to a signboard.

12. The indicator according to claim 1, wherein said indicator is installed on shoes.

13. The indicator according to claim 1, wherein said indicator is installed on a hat.

14. The indicator according to claim 1, wherein said indicator is installed on clothes.

15. A multi-function super-thin indicator comprising:
a thin electroluminescent laminate having a lightening portion representing substantially the same displaying area, and said lightening portion including plural sets of sub-lightening portions that can self-luminance; several stripe-shaped lightening segments, which are substantially mutual parallel and separated to each other, constituting each sub-lightening portion; a lightening segment of other sub-lightening portion being plugged in between two lightening segments next to each other of same sub-lightening portion; and
a figure portion, which is stacked on said lightening portion, having several sets of figures and each set of figures being constituted by several stripe-shaped figure segments that are substantially mutual parallel and separated to each other; each figure segment corresponding in location to one of said lightening segments; each set of figures corresponding in location to one of said sub-lightening portions and being lightened by one of said corresponding sub-lightening portions.

16. The indicator according to claim 15, wherein the groups of figures represent different meanings.

17. The indicator according to claim 16, wherein the sub-lightening portion can luninesce independently and separately, so that the lightening portion will luminesce after the other lightening portions have luminesced.

18. The indicator according to claim 17, wherein each set of figures further contains several sub figures, the lightening segments of each sub-lightening portion are divided into several groups, each lightening segment corresponds to a sub figure, and each group of lightening segment luminesces one by one in sequence.

19. The indicator according to claim 15, wherein the sets of figures represent the same meaning.

20. The indicator according to claim 19, wherein the sub-lightening portions luminesce one by one in sequence.

21. The indicator according to claim 1, wherein said indicator is installed on a backpack.

22. The indicator according to claim 1, wherein said indicator is installed on a belt.

23. The indicator according to claim 1, wherein said indicator is applied to a signboard.

24. The indicator according to claim 1, wherein said indicator is installed on shoes.

25. The indicator according to claim 1, wherein said indicator is installed on a hat.

26. The indicator according to claim 1, wherein said indicator is installed on clothes.
